(19) United States
(12) Patent Application Publication
(10) Pub. No.: US 2011/0061954 A1
(43) Pub. Date: Mar. 17, 2011

(54) STRONG HYBRID SYSTEM

(75) Inventors: Tejinder Singh, Commerce Township, MI (US); Henryk Sowul, Oxford, MI (US); Victor M. Roses, Ann Arbor, MI (US); Randy Lewis Melanson, Pinckney, MI (US); Shawn H. Swales, Canton, MI (US)

(73) Assignee: GM GLOBAL TECHNOLOGY OPERATIONS, INC., Detroit, MI (US)

(21) Appl. No.: 12/557,928

(22) Filed: Sep. 11, 2009

(51) Int. Cl. B60K 6/42

(52) U.S. Cl. 180/65.22; 180/65.21

(57) ABSTRACT

A powertrain for a vehicle includes an engine, a transmission and a coupling system interconnecting the engine and the transmission. The coupling system includes an electric motor/generator. The electric motor/generator is coupled to an input shaft. An engine disconnect clutch interconnects the engine with the input shaft. A fluid coupling interconnects the input shaft and the transmission. The engine disconnect shaft is moveable between an engaged position and a disengaged position for starting the engine and/or isolating the electric motor/generator from the engine. The engine disconnect clutch includes a default position disconnecting the electric motor/generator from the engine.

### TECHNICAL FIELD

The present invention generally relates to a hybrid system for a vehicle, and more specifically to a strong hybrid system including a single electric motor/generator.

### BACKGROUND OF THE INVENTION

Many vehicles now include a hybrid powertrain system that includes an engine and a multi-speed transmission. The engine typically includes an internal combustion engine, and produces a torque, which is transferred through the transmission to wheels of the vehicle. The transmission increases the overall operating range of the vehicle by permitting the engine to operate through its torque range a number of times. The hybrid powertrain systems include a coupling system disposed between the engine and the transmission. The coupling system augments, i.e., adds to, the torque provided by the engine.

The coupling system may improve vehicle fuel economy in a variety of ways. For instance, the engine may be turned off at idle, during periods of deceleration and braking, and during periods of low speed or light load operation to eliminate efficiency losses due to engine drag. Captured braking energy (via regenerative braking) or energy stored by an electric motor acting as a generator during periods when the engine is operating is utilized during these engine off periods. Transient demand for engine torque or power is supplemented by the electric motor during operation in engine-on, electric modes, allowing for downsizing the engine without reducing apparent vehicle performance. Additionally, the engine may be operated at or near the optimal efficiency point for a given power demand. The motor/generator is able to capture vehicle kinetic energy during braking, which is used to keep the engine off longer, supplement engine torque or power and/or operate at a lower engine speed, or supplement accessory power supplies. Additionally, the electric motor/generator is very efficient in accessory power generation and electric power from the battery serves as an available torque reserve allowing operation at a relatively low transmission numerical speed ratio.

### SUMMARY OF THE INVENTION

A powertrain for a vehicle is provided. The powertrain includes an engine and a transmission. The engine is configured for supplying torque. A coupling system interconnects the engine and the transmission. The coupling system includes an input shaft coupled to the engine. The input shaft is configured for receiving torque from the engine. The coupling system further includes an engine disconnect clutch, which selectively interconnects the engine and the input shaft. The engine disconnect clutch is moveable between an engaged position and a disengaged position. The engaged position is configured for selectively connecting the input shaft with the engine to transmit torque from the engine to the input shaft. The disengaged position is configured for selectively disconnecting the input shaft from the engine to prevent transmission of torque between the engine and the input shaft. The coupling system further includes an electric motor/generator coupled to the input shaft. The electric motor is configured for supplying torque to the input shaft for transfer to at least one of the engine and the transmission, and is also configured for receiving torque from the input shaft for generating electricity. The coupling system further includes a fluid coupling interconnecting the input shaft and the transmission. The fluid coupling is configured for transmitting torque from the input shaft to the transmission. The coupling system further includes a transmission fluid pump. The transmission fluid pump is coupled to the input shaft, and is operable in response to torque from the input shaft. The transmission fluid pump supplies a fluid pressure to the engine disconnect clutch and the transmission at a pre-determined pressure. The powertrain operates in a first state of operation, a second state of operation and a third state of operation. The electric motor/generator supplies torque to the input shaft to operate the transmission fluid pump in the first state of operation. The engine supplies torque to the input shaft to operate the transmission fluid pump in the second state of operation. Both the engine and the electric motor/generator supply torque to the input shaft to operate the transmission fluid pump in the third state of operation.

In another aspect of the invention, a coupling system for a vehicle having an engine and a transmission is provided. The coupling system includes an input shaft. The input shaft is configured for receiving torque from the engine. The coupling system further includes an electric motor/generator coupled to the input shaft. The electric motor/generator is configured for alternatively supplying torque to the input shaft for transfer to at least one of the engine and the transmission, and is also configured for receiving torque from the input shaft for generating electricity. An engine disconnect clutch is attached to the input shaft. The engine disconnect clutch is moveable between an engaged position and a disengaged position. The engaged position is configured for selectively connecting the input shaft with the engine to transmit torque from the engine to the input shaft. The disengaged position is configured for selectively disconnecting the input shaft from the engine to prevent transmission of torque between the engine and the input shaft. A fluid coupling is attached to the input shaft. The fluid coupling is configured for transmitting torque from the input shaft to the transmission. A transmission fluid pump is coupled to the input shaft. The transmission fluid pump receives torque from the input shaft, and is configured for supplying a fluid pressure to the engine disconnect clutch and the transmission at a pre-determined pressure in response to torque transmitted through the input shaft.

In another aspect of the invention, a transmission for a vehicle is provided. The transmission includes a housing having a bell portion and a gear portion. A coupling system is disposed within the bell portion of the housing. The coupling system is configured for coupling to an engine of the vehicle. The coupling system includes an input shaft configured for receiving torque from the engine. The coupling system further includes an engine disconnect clutch configured for selectively interconnecting the input shaft and the engine. The engine disconnect clutch is moveable between an engaged position and a disengaged position. The engaged position is configured for selectively connecting the input shaft with the engine to transmit torque between the engine and the input shaft. The disengaged position is configured for selectively disconnecting the input shaft from the engine to prevent transmission of torque between the engine and the input shaft. The coupling system further includes an electric motor/generator coupled to the input shaft. The electric motor/generator is configured for supplying a torque to the input shaft for transfer to at least one of the engine and the transmission, and is also configured for receiving a torque from the input shaft for generating electricity. The coupling system further includes a fluid coupling configured for interconnecting the input shaft and the transmission to transmit torque from the input shaft to the transmission. The coupling system further includes a transmission fluid pump coupled to the input shaft. The transmission fluid pump is operable in response to torque from the input shaft to supply a fluid pressure to the engine disconnect clutch and the transmission at a pre-determined pressure. The engaged position of the engine disconnect clutch is a default position of the engine disconnect clutch.

Accordingly, the coupling system is selectively coupled to the engine to permit selective engagement/disengagement between the engine and the transmission. As such, in the event the coupling system fails, the vehicle is operable as a standard vehicle, i.e., a vehicle without a coupling system, by disengaging the coupling system. Additionally, both the engine and the electric motor of the coupling system are directly coupled to the transmission fluid pump, thereby eliminating the need for the coupling system to include an auxiliary electric motor and transmission fluid pump. Elimination of an auxiliary electric motor and transmission fluid pump in the coupling system reduces the possibility of the coupling system failing by reducing the number of operation components in the coupling system.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic perspective view of a transmission.

FIG. 2 is a schematic diagram showing a first embodiment of a coupling system in a powertrain of a vehicle.

FIG. 3 is a schematic diagram showing a second embodiment of the coupling system in the powertrain of the vehicle.

### DESCRIPTION OF THE PREFERRED EMBODIMENTS

Referring to the Figures, wherein like numerals indicate corresponding parts throughout the several views, a powertrain for a vehicle is shown generally at 20. The powertrain 20 includes an engine 22, a coupling system 24 and a transmission 26. The powertrain 20 produces a torque and transfers the torque to one or more wheels of the vehicle.

The engine 22 is configured to supply a torque. Depending upon the operational state of the powertrain 20, described in greater detail below, the engine 22 may supply all of the torque necessary to operate the vehicle, or may only supply a portion of the torque necessary to operate the vehicle. The engine 22 preferably includes an internal combustion engine. However, it should be appreciated that the engine 22 may include some other type of engine capable of providing a torque sufficient to power the vehicle.

The transmission 26 is configured to receive a torque and transmit the torque to at least one wheel of the vehicle. The transmission 26 preferably includes a multi-speed automatic transmission 26 including a plurality of planetary gear-sets, clutches, bands, etc., as is well known in the art. The transmission 26 increases the overall operating range of the vehicle by permitting the engine 22 to operate through its torque range a number of times. While described as a multi-speed automatic transmission, it should be appreciated that the transmission 26 may include some other type of transmission not shown or described herein, capable of transmitting torque to the wheels of the vehicle, and suitable for use with a coupling system 24.

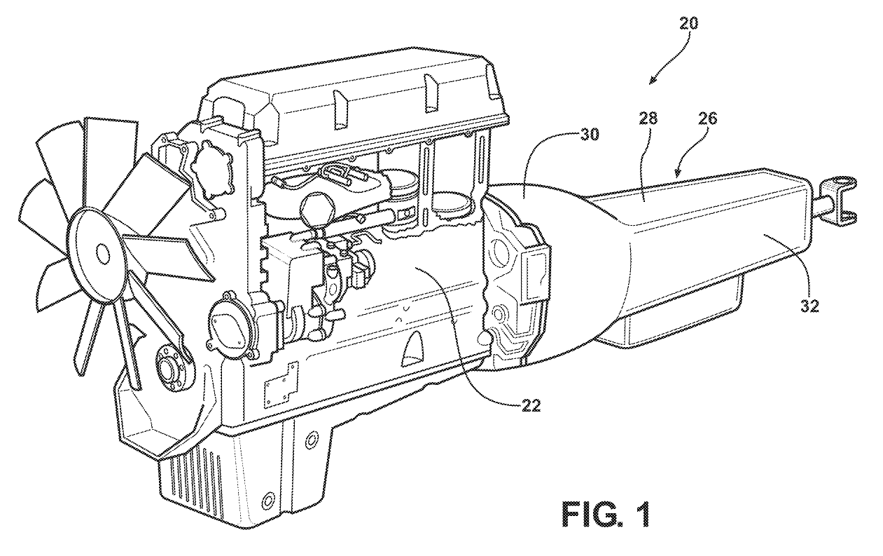

Referring to FIG. 1, the transmission 26 includes a housing 28. The housing 28 includes a bell portion 30 and a gear portion 32. The gear portion 32 houses the planetary gear-sets, clutches, bands, etc. of the transmission 26. Preferably, the bell portion 30 houses the coupling system 24, i.e., the coupling system 24 is part of the transmission 26. However, it should be appreciated that the coupling system 24 may be separate from the transmission 26 and disposed outside of the bell portion 30 of the housing 28, between the engine 22 and the transmission 26.

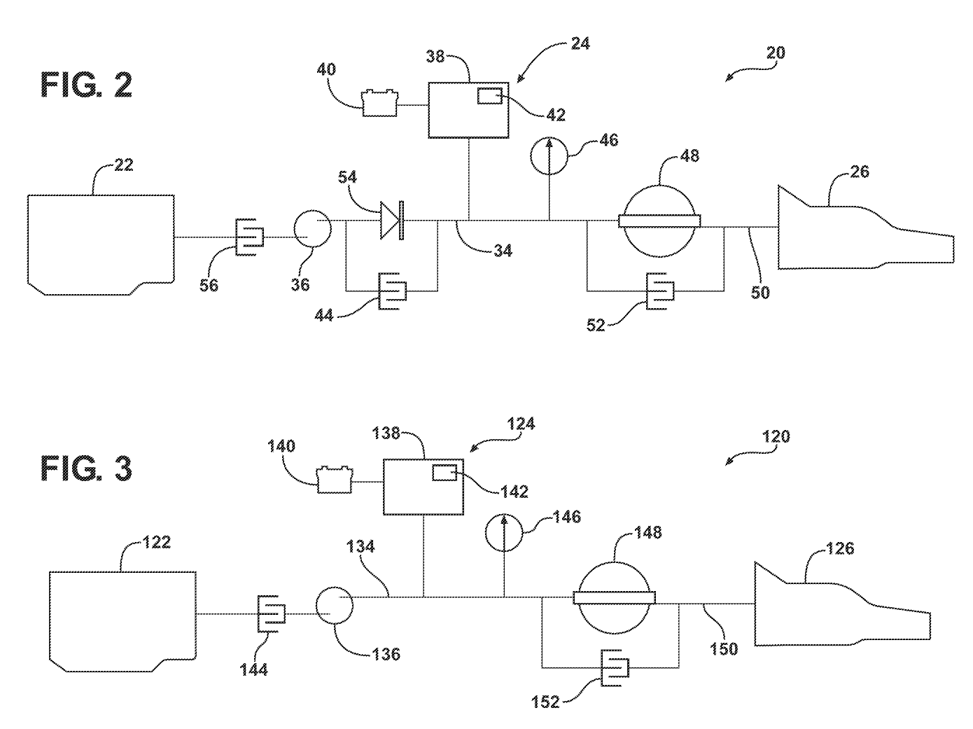

Referring to FIG. 2, a first embodiment of the coupling system 24 is shown. The coupling system 24 interconnects the engine 22 and the transmission 26. More specifically, the coupling system 24 interconnects the engine 22 and the gear portion 32 of the transmission 26. The coupling system 24 may be utilized to provide torque to the transmission 26 independently from the engine 22, or in combination with the engine 22 as is described in greater detail below.

The coupling system 24 includes an input shaft 34. The input shaft 34 is coupled to the engine 22, and is configured to receive torque from the engine 22. The engine 22 may be coupled to the input shaft 34 in any suitable manner. The coupling system 24 may include a damper 36 configured for attenuating vibration from the engine 22 in the input shaft 34. The damper 36 is disposed adjacent the engine 22 and may include any suitable damper 36 known to those skilled in the art.

The coupling system 24 includes an electric motor 38 coupled to a battery 40. The electric motor 38 may be coupled to the battery 40 in any suitable manner. The electric motor 38 includes a generator 42, and is hereinafter referred to as the electric motor/generator 38. Accordingly, the electric motor/generator 38 is operable to generate torque, and is alternatively operable to generate electricity as a generator 42, with the electricity being stored in the battery 40 as is well known. The electric motor/generator 38 is a single operational unit, i.e., the electric motor 38 and the generator 42 are combined and are not separate components. The electric motor/generator 38 utilizes electricity stored in the battery 40 to generate a torque to operate the vehicle. Additionally, the electric motor/generator 38 receives a torque to generate electricity for storage in the battery 40.

The electric motor/generator 38 is coupled to the input shaft 34, and is configured for supplying torque to the input shaft 34. The electric motor/generator 38 may be coupled to the input shaft 34 in any suitable manner. Accordingly, the input shaft 34 may receive torque from only the engine 22, only the electric motor/generator 38, or both the engine 22 and the electric motor/generator 38. The torque supplied to the input shaft 34 from the electric motor/generator 38 is transferred to at least one of the engine 22 and the transmission 26. The generator 42 of the electric motor/generator 38 is also configured to receive torque from the input shaft 34. It should be appreciated that the electric motor/generator 38 receives the torque from the input shaft 34 to generating electricity, and more specifically, the generator 42 of the electric motor/generator 38 receives the torque from the input shaft 34 to generate electricity.

The coupling system 24 includes an engine disconnect clutch 44. The engine disconnect clutch 44 selectively interconnects the engine 22 and the input shaft 34. The engine disconnect clutch 44 is moveable between an engaged position and a disengaged position. The engaged position is configured for selectively connecting the input shaft 34 with the engine 22 to transmit torque from the engine 22 to the input shaft 34. The disengaged position is configured for selectively disconnecting the input shaft 34 from the engine 22 to prevent transmission of torque between the engine 22 and the input shaft 34. Accordingly, the operating states of the powertrain 20 are changed by changing the engine disconnect clutch 44 between the engaged position and the disengaged position. The engine disconnect clutch 44 may include a spring loaded clutch, or some other type of clutch capable of selectively connecting and disconnecting the engine 22 and the input shaft 34 that is not shown or described herein.

The transmission 26 includes a transmission fluid pump 46. The transmission fluid pump 46 is preferably disposed within the transmission housing 28, but may alternatively be disposed outside the transmission housing 28. The transmission fluid pump 46 is coupled to the input shaft 34, and is operable in response to torque from the input shaft 34. Accordingly, the transmission fluid pump 46 is operable in response to torque supplied by the engine 22, torque supplied by the electric motor/generator 38 or torque supplied by both the engine 22 and the electric motor/generator 38. The transmission fluid pump 46 supplies a fluid at a pre-determined fluid pressure to the transmission 26 to enable the transmission 26 to function properly.

The engine disconnect clutch 44 may include a hydraulically actuated clutch. If so, the engine disconnect clutch 44 may be in fluid communication with the transmission fluid pump 46, wherein the engine disconnect clutch 44 is moveable into the disengaged position in response to a fluid pressure supplied by the transmission fluid pump 46. As such, the transmission fluid pump 46 supplies the fluid at the pre-determined fluid pressure to the engine disconnect clutch 44 to actuate the engine disconnect clutch 44 between the disengaged position and the engaged position. Accordingly, the engine disconnect clutch 44 is operable to move into the disengaged position only when one of the engine 22 and/or the electric motor/generator 38 is supplying a torque to the input shaft 34 to actuate the transmission fluid pump 46.

The coupling system 24 further includes a fluid coupling 48 interconnecting the input shaft 34 and the transmission 26. The fluid coupling 48 is configured to transmit torque from the input shaft 34 to the transmission 26. More specifically, the coupling system 24 includes an output shaft 50 interconnecting the fluid coupling 48 and the transmission 26, with the fluid coupling 48 interconnecting the input shaft 34 and the output shaft 50. The output shaft 50 is coupled to the gear portion 32 of the transmission 26 to supply the torque to the gear portion 32. The fluid coupling 48 permits relative movement, i.e., slippage, between the input shaft 34 and the output shaft 50 until the output shaft 50 is brought up to a comparable rotational speed as the input shaft 34.

The coupling system 24 further includes a locking clutch 52 interconnecting the input shaft 34 and the output shaft 50. The locking clutch 52 is moveable between a locked position and an unlocked position. The fluid coupling 48 is locked when the locking clutch 52 is in the locked position to prevent relative movement between the input shaft 34 and the output shaft 50. The fluid coupling 48 is released when the locking clutch 52 is in the unlocked position to permit relative movement between the input shaft 34 and the output shaft 50. Once the output shaft 50 is brought up to a comparable rotational speed relative to the input shaft 34, the locking clutch 52 locks the fluid coupling 48 to prevent slippage between the input shaft 34 and the output shaft 50 to improve fuel efficiency.

The coupling system 24 may further include a one way clutch 54 interconnecting the engine 22 and the input shaft 34. The one way clutch 54 is configured to permit torque transfer from the engine 22 to the transmission 26 and to not transmit torque transfer from the electric motor/generator 38 to the engine 22. As such, the one way clutch 54 is disposed between the engine 22 and the electric motor/generator 38. In other words, the one way clutch 54 only transmits torque from the engine 22 into the powertrain 20, and does not transmit torque back into the engine 22.

The engine disconnect clutch 44 and the one way clutch 54 are arranged in parallel with each other. As such, when the engine disconnect clutch 44 is in the disengaged position, both the one way clutch 54 and the engine disconnect clutch 44 are configured to not transmit torque to the engine 22, thereby disengaging the electric motor/generator 38 of the coupling system 24 from the engine 22. However, the engine 22 is still coupled to the input shaft 34 to supply torque to the input shaft 34 through the one way clutch 54. When the engine disconnect clutch 44 is in the engaged position, the input shaft 34 may transmit torque to the engine 22 through the engine disconnect clutch 44, for example, to start the engine 22 as described below.

Preferably, but not necessarily, in the first embodiment of the coupling system 24, the disengaged position of the engine disconnect clutch 44 is a default position of the engine disconnect clutch 44, i.e., the disengaged position is the position the engine disconnect clutch 44 defaults to in the absence of a signal to change to the engaged position. Accordingly, the default position of the engine disconnect clutch 44 ensures that torque is not transferable to the engine 22, while still allowing torque transfer from the engine 22 to the input shaft 34 through the one way clutch 54. As such, the engine 22 is disconnected from the coupling system 24 as a default to ensure that the engine 22 may be utilized to power the vehicle in the event the coupling system 24 fails.

The coupling system 24 may further include a torque limiting device 56 interconnecting the engine 22 and the input shaft 34. The torque limiting device 56 is configured to limit torque transfer between the engine 22 and the input shaft 34 to below a pre-determined level. Accordingly, if the torque from the engine 22 exceeds the pre-determined level, the torque limiting device 56 begins to slip, i.e., limit, the torque transferred to the input shaft 34. The torque limiting device 56 may include a spring loaded clutch, or some other device capable of limiting torque transfer to below a pre-determined level, that is not shown or described herein.

The powertrain 20 operates in a first state of operation, a second state of operation and a third state of operation. In the first state of operation, only the electric motor/generator 38 supplies torque to the input shaft 34 to operate the transmission fluid pump 46. In the second state of operation, only the engine 22 supplies torque to the input shaft 34 to operate the transmission fluid pump 46. In the third state of operation, both of the engine 22 and the electric motor/generator 38 supply torque to the input shaft 34 to operate the transmission fluid pump 46. When the powertrain 20 is operating in the second state of operation, the engine 22 may also supply torque to the input shaft 34 to operate the generator 42 of the electric motor/generator 38 to generate electricity.

The first state of operation is generally associated with normal, initial startup and operation of the vehicle below a pre-determined speed or torque requirement. In the first state of operation, the electric motor/generator 38 generates the torque and supplies the torque to the input shaft 34, and the engine disconnect clutch 44 is in the disengaged position. The input shaft 34 supplies the torque to the transmission fluid pump 46, which pressurizes the transmission fluid. The torque from the electric motor/generator 38 flows from the electric motor/generator 38, through the input shaft 34, through the fluid coupling 48 into the output shaft 50, and then into the transmission 26. Once the output shaft 50 and the input shaft 34 are operating at a comparable speed, the locking clutch 52 may be engaged to lock the fluid coupling 48 to prevent relative slippage between the input shaft 34 and the output shaft 50. The disengaged position of the engine disconnect clutch 44 and the one way clutch 54 do not transfer torque to the engine 22.

The second state of operation is generally associated with a failure in the coupling system 24, in which case the engine 22 provides all of the power to the vehicle and bypasses the coupling system 24. In the second state of operation, the engine 22 generates the torque and supplies the torque to the input shaft 34. The input shaft 34 transmits the torque through the torque limiting device 56, the damper 36, and the one way clutch 54 to supply the transmission fluid pump 46 with torque to actuate the transmission fluid pump 46. The transmission fluid pump 46 pressurizes the transmission fluid to a sufficient pressure to operate the transmission 26. The torque from the engine 22 flows through the input shaft 34, through the fluid coupling 48 into the output shaft 50, and then into the transmission 26. Once the output shaft 50 and the input shaft 34 are operating at a comparable rotational speed, the locking clutch 52 may be engaged to lock the fluid coupling 48 to prevent relative slippage between the input shaft 34 and the output shaft 50. If the engine 22 includes an internal combustion engine 22, then the engine 22 must include a standard 12 volt starter or the like to start the engine 22 to operate the powertrain 20 in the second state of operation.

When in the second state of operation, it should be appreciated that the electric motor/generator 38 may receive torque from the engine 22 to operate the generator 42 of the electric motor/generator 38, to thereby generate electricity and charge the battery 40.

The third state of operation is generally associated with operation of the vehicle above the pre-determined speed or torque requirement. In the third state of operation, the engine 22 is the primary supply of torque, with the electric motor/generator 38 adding torque to supplement the engine 22 to meet the various high speed and/or high torque driving conditions. The powertrain 20 enters the third state of operation upon reaching the upper limits of the first state of operation, i.e., the vehicle begins startup and normal operation in the first state of operation and then moves into the third state of operation when the coupling system 24 is no longer capable of supplying sufficient torque to the powertrain 20 by itself.

Assuming the powertrain 20 is operating in the first state of operation, the electric motor/generator 38 supplies the torque to the input shaft 34, which actuates the transmission fluid pump 46. The transmission fluid pump 46 supplies the pressurized fluid to the engine disconnect clutch 44 to move the engine disconnect clutch 44 into the engaged position when signaled to permit torque transfer to the engine 22. The torque entering the engine 22 through the engine disconnect clutch 44 rotates a crankshaft of the engine 22. After the crankshaft of the engine 22 reaches a sufficient rotating speed, the engine 22 fires and begins to operate. Once the engine 22 is operating, the torque flows from the engine 22 to the input shaft 34 through the one way clutch 54. After the engine 22 has fired and is in operation, the engine disconnect clutch 44 is preferably, but not necessarily, moved back into the disengaged position. In the third state of operation, the electric motor/generator 38 is selectively utilized to supplement the engine 22. When the electric motor/generator 38 is not required to supply additional torque to the powertrain 20, the generator 42 of the electric motor/generator 38 may be engaged to generate electricity to charge the battery 40.

Referring to FIG. 3, a second embodiment of the coupling system is shown generally at 124. Throughout the description of the second embodiment of the coupling system 124 and FIG. 3, reference numerals utilized to describe features of the second embodiment of the coupling system 124 that are similar to the features of the first embodiment of the coupling system 24 include the same reference numeral increased by one hundred. For example, the electric motor, identified by the reference numeral 38 in the first embodiment of the coupling system 24, is identified by the reference numeral 138 in the second embodiment of the coupling system 124.

The second embodiment of the coupling system 124 includes an input shaft 134. The input shaft 134 is coupled to the engine 122, and is configured to receive torque from the engine 122. The engine 122 may be coupled to the input shaft 134 in any suitable manner. The second embodiment of the coupling system 124 may include a damper 136 configured for attenuating vibration in the input shaft 134 from the engine 122. The damper 136 is disposed adjacent the engine 122 and may include any suitable damper 136 known to those skilled in the art.

The second embodiment of the coupling system 124 includes an electric motor 138 coupled to a battery 140. The electric motor 138 may be coupled to the battery 140 in any suitable manner. The electric motor 138 includes a generator 142, and is hereinafter referred to as the electric motor/generator 138. Accordingly, the electric motor/generator 138 is operable to generate torque as a motor, and is alternatively operable to generate electricity as a generator, which is stored in the battery 140 as is well known. The electric motor/generator 138 is a single operational unit, i.e., the electric motor 138 and the generator 142 are combined and are not separate components. The electric motor/generator 138 utilizes electricity stored in the battery 140 to generate a torque to operate the vehicle. Additionally, the electric motor/generator 138 receives a torque to generate electricity for storage in the battery 140.

The electric motor/generator 138 is coupled to the input shaft 134, and is configured for supplying torque to the input shaft 134. The electric motor/generator 138 may be coupled to the input shaft 134 in any suitable manner. Accordingly, the input shaft 134 may receive torque from only the engine 122, only the electric motor/generator 138, or both the engine 122 and the electric motor/generator 138. The torque supplied to the input shaft 134 from the electric motor/generator 138 is transferred to at least one of the engine 122 and the transmission 126. The generator 142 of the electric motor/generator 138 is also configured to receive torque from the input shaft 134. It should be appreciated that the electric motor/generator 138 receives the torque from the input shaft 134 to generate electricity, and more specifically, the generator 142 of the electric motor/generator 138 receives the torque from the input shaft 134 to generate electricity.

The second embodiment of the coupling system 124 includes an engine disconnect clutch 144. The engine disconnect clutch 144 selectively interconnects the engine 122 and the input shaft 134. The engine disconnect clutch 144 is moveable between an engaged position and a disengaged position. The engaged position is configured for selectively connecting the input shaft 134 with the engine 122 to transmit torque from the engine 122 to the input shaft 134. The disengaged position is configured for selectively disconnecting the input shaft 134 from the engine 122 to prevent transmission of torque between the engine 122 and the input shaft 134. Accordingly, the operating states of the powertrain 120 are changed by changing the engine disconnect clutch 144 between the engaged position and the disengaged position. The engine disconnect clutch 144 may include a spring loaded clutch, or some other type of clutch capable of selectively connecting and disconnecting the engine 122 and the input shaft 134 that is not shown or described herein.

The transmission 126 includes a transmission fluid pump 146. The transmission fluid pump 146 is preferably disposed within the transmission housing, identified in FIG. 1 by reference numeral 28, but may alternatively be disposed outside the transmission housing 28. The transmission fluid pump 146 is coupled to the input shaft 134, and is operable in response to torque from the input shaft 134. Accordingly, the transmission fluid pump 146 is operable in response to torque supplied by the engine 122, torque supplied by the electric motor/generator 138 or torque supplied by both the engine 122 and the electric motor/generator 138. The transmission fluid pump 146 supplies a fluid at a pre-determined fluid pressure to the transmission 126 to enable the transmission 126 to function properly.

The engine disconnect clutch 144 may include a hydraulically actuated clutch. If so, the engine disconnect clutch 144 may be in fluid communication with the transmission fluid pump 146, wherein the engine disconnect clutch 144 is moveable into the disengaged position in response to a fluid pressure supplied by the transmission fluid pump 146. As such, the transmission fluid pump 146 supplies the fluid at the pre-determined fluid pressure to the engine disconnect clutch 144 to actuate the engine disconnect clutch 144 between the disengaged position and the engaged position. Accordingly, the engine disconnect clutch 144 is operable to move into the disengaged position only when one of the engine 122 and/or the electric motor/generator 138 is supplying a torque to the input shaft 134 to actuate the transmission fluid pump 146.

Preferably, the engaged position of the engine disconnect clutch 144 is a default position of the engine disconnect clutch 144, i.e., the engaged position is the position the engine disconnect clutch 144 defaults to in the absence of a signal to change to the disengaged position. Accordingly, the default position of the engine disconnect clutch 144 ensures the engine 122 is coupled to the transmission 126 in the event the coupling system 124 fails. As such, the vehicle is operable as a standard internal combustion vehicle in the event the coupling system 124 fails.

The second embodiment of the coupling system 124 further includes a fluid coupling 148 interconnecting the input shaft 134 and the transmission 126. The fluid coupling 148 is configured to transmit torque from the input shaft 134 to the transmission 126. More specifically, the coupling system 124 includes an output shaft 150 interconnecting the fluid coupling 148 and the transmission 126, with the fluid coupling 148 interconnecting the input shaft 134 and the output shaft 150. The output shaft 150 is coupled to the gear portion 32 of the transmission 126 to supply the torque to the gear portion 32. The fluid coupling 148 permits relative movement, i.e., slippage, between the input shaft 134 and the output shaft 150 until the output shaft 150 is brought up to the same rotational speed as the input shaft 134.

The second embodiment of the coupling system 124 further includes a locking clutch 152 interconnecting the input shaft 134 and the output shaft 150. The locking clutch 152 is moveable between a locked position and an unlocked position. The locked position locks the fluid coupling 148 to prevent relative movement between the input shaft 134 and the output shaft 150. The unlocked position releases the fluid coupling 148 to permit relative movement between the input shaft 134 and the output shaft 150. Once the output shaft 150 is brought up to a comparable rotational speed as the input shaft 134, the locking clutch 152 locks the fluid coupling 148 to prevent slippage between the input shaft 134 and the output shaft 150 to improve fuel efficiency.

The powertrain 120 including the second embodiment of the coupling system 124 shown in FIG. 3 operates in a first state of operation, a second state of operation and a third state of operation. In the first state of operation, only the electric motor/generator 138 supplies torque to the input shaft 134 to operate the transmission fluid pump 146. In the second state of operation, only the engine 122 supplies torque to the input shaft 134 to operate the transmission fluid pump 146. In the third state of operation, both of the engine 122 and the electric motor/generator 138 supply torque to the input shaft 134 to operate the transmission fluid pump 146. When the powertrain 120 is operating in the second state of operation, the engine 122 may also supply torque to the input shaft 134 to operate the generator 142 of the electric motor/generator 138 to generate electricity.

The first state of operation is generally associated with normal, initial startup and operation of the vehicle below a pre-determined speed or torque requirement. In the first state of operation, the electric motor/generator 138 generates the torque and supplies the torque to the input shaft 134, and the engine disconnect clutch 144 is in the engaged position. The input shaft 134 supplies the torque to the transmission fluid pump 146, which pressurizes the transmission fluid and supplies the pressurized fluid to the engine disconnect clutch 144. The pressurized fluid moves the engine disconnect clutch 144 from the default engaged position into the disengaged position to disengage the engine 122 from the input shaft 134 and the electric motor/generator 138. The torque from the electric motor/generator 138 flows from the electric motor/generator 138, through the input shaft 134, through the fluid coupling 148 into the output shaft 150, and then into the transmission 126. Once the output shaft 150 and the input shaft 134 are operating at a comparable rotational speed, the locking clutch 152 may be engaged to lock the fluid coupling 148 to prevent relative slippage between the input shaft 134 and the output shaft 150.

The second state of operation is generally associated with a failure in the coupling system 124, in which case the engine 122 provides all of the power to the vehicle and bypasses the coupling system 124. In the second state of operation, the engine disconnect clutch 144 is in the default engaged position. The engine 122 generates the torque and supplies the torque to the input shaft 134 through the engine disconnect clutch 144. The input shaft 134 transmits the torque through the damper 136, to supply the transmission fluid pump 146 with torque to actuate the transmission fluid pump 146. The transmission fluid pump 146 pressurizes the transmission fluid to a sufficient pressure to operate the transmission 126. The torque from the engine 122 flows through the input shaft 134, through the fluid coupling 148 into the output shaft 150, and then into the transmission 126. Once the output shaft 150 and the input shaft 134 are operating at a comparable rotational speed, the locking clutch 152 may be engaged to lock the fluid coupling 148 to prevent relative slippage between the input shaft 134 and the output shaft 150. If the engine 122 includes an internal combustion engine 122, then the engine 122 must include a standard 12 volt starter or the like to start the engine 122 to operate the powertrain 120 in the second state of operation.

When in the second state of operation, it should be appreciated that the electric motor/generator 138 may receive torque from the engine 122 to operate the generator 142 of the electric motor/generator 138, to thereby generate electricity and charge the battery 140.

The third state of operation is generally associated with operation of the vehicle above the pre-determined speed or torque requirement. In the third state of operation, the engine 122 is the primary supply of torque, with the electric motor/generator 138 adding torque to supplement the engine 122 to meet the various high speed or high torque driving conditions. The third state of operation normally, but not necessarily, begins upon the powertrain 120 reaching the upper limits of the first state of operation, i.e., the vehicle begins startup and normal operation in the first state of operation and then moves into the third state of operation when the coupling system 124 is no longer capable of supplying sufficient torque to the powertrain 120 by itself.

Assuming the powertrain 120 is operating in the first state of operation with the engine disconnect clutch 144 in the disengaged position, the electric motor/generator 138 supplies the torque to the input shaft 134, which actuates the transmission fluid pump 146. The transmission fluid pump 146 supplies the pressurized fluid to the engine disconnect clutch 144 to move the engine disconnect clutch 144 into the engaged position to permit torque transfer to the engine 122. The torque entering the engine 122 through the engine disconnect clutch 144 rotates a crankshaft of the engine 122. After the crankshaft of the engine 122 reaches a sufficient rotating speed, the engine 122 fires and begins to operate. Once the engine 122 is operating, the torque flows from the engine 122 to the input shaft 134 through engine disconnect clutch 144, which remains in the default engaged position. In the third state of operation, the electric motor/generator 138 is selectively utilized to supplement the engine 122. When the electric motor/generator 138 is not required to supply additional torque to the powertrain 120, the generator 142 of the electric motor/generator 138 may be engaged to generate electricity to charge the battery 140.

While the best modes for carrying out the invention have been described in detail, those familiar with the art to which this invention relates will recognize various alternative designs and embodiments for practicing the invention within the scope of the appended claims.

1. A powertrain for a vehicle, the powertrain comprising:
an engine configured for supplying torque;
a transmission; and
a coupling system interconnecting said engine and said transmission, said coupling system including:
an input shaft coupled to said engine and configured for receiving torque from said engine;
an engine disconnect clutch selectively interconnecting said engine and said input shaft and moveable between an engaged position and a disengaged position, wherein said engaged position is configured for selectively connecting said input shaft with said engine to transmit torque from said engine to said input shaft and said disengaged position is configured for selectively disconnecting said input shaft from said engine to prevent transmission of torque between said engine and said input shaft;
an electric motor/generator coupled to said input shaft and configured for supplying torque to said input shaft for transfer to at least one of said engine and said transmission and receiving torque from said input shaft for generating electricity;
a fluid coupling interconnecting said input shaft and said transmission and configured for transmitting torque from said input shaft to said transmission; and
a transmission fluid pump coupled to said input shaft and operable in response to torque from said input shaft to supply a fluid pressure to said transmission at a pre-determined pressure;
wherein said electric motor/generator supplies torque to said input shaft to operate said transmission fluid pump in a first state of operation, said engine supplies torque to said input shaft to operate said transmission fluid pump in a second state of operation, and both of said engine and said electric motor/generator supply torque to said input shaft to operate said transmission fluid pump in a third state of operation.

2. A powertrain as set forth in claim 1 wherein said engine disconnect clutch includes a default position, wherein said default position is one of said engaged position of said engine disconnect clutch and said disengaged position of said engine disconnect clutch.

3. A powertrain as set forth in claim 2 wherein said engine disconnect clutch is in fluid communication with said transmission fluid pump and wherein said engine disconnect clutch is moveable out of said default position in response to a fluid pressure supplied by said transmission fluid pump.

4. A powertrain as set forth in claim 1 wherein said coupling system further includes an output shaft interconnecting said fluid coupling and said transmission.

5. A powertrain as set forth in claim 4 wherein said coupling system further includes a locking clutch interconnecting said input shaft and said output shaft and moveable between a locked position and an unlocked position, wherein said fluid coupling is locked when said locking clutch is in said locked position to prevent relative movement between said input shaft and said output shaft and said fluid coupling is released when said locking clutch is in said unlocked position to permit relative movement between said input shaft and said output shaft.

6. A powertrain as set forth in claim 1 wherein said coupling system further includes a one way clutch interconnecting said engine and said input shaft and configured for transferring torque from said engine to said transmission and not transferring torque from said input shaft to said engine.

7. A powertrain as set forth in claim 6 wherein said engine disconnect clutch and said one way clutch are arranged in parallel with each other.

8. A powertrain as set forth in claim 1 wherein said coupling system further includes a torque limiting device interconnecting said engine and said input shaft and configured for limiting torque transfer between said engine and said input shaft to below a pre-determined level.

9. A coupling system for a vehicle including an engine and a transmission, the coupling system comprising:
an input shaft configured for receiving torque from the engine;
an electric motor/generator coupled to said input shaft and configured for alternatively supplying torque to said input shaft for transfer to at least one of the engine and the transmission and receiving torque from said input shaft for generating electricity;
an engine disconnect clutch attached to said input shaft and moveable between an engaged position and a disengaged position wherein said engaged position is configured for selectively connecting said input shaft with the engine to transmit torque from the engine to said input shaft and said disengaged position is configured for selectively disconnecting said input shaft from the engine to prevent transmission of torque between the engine and said input shaft;
a fluid coupling attached to said input shaft and configured for transmitting torque from said input shaft to the transmission; and
a transmission fluid pump coupled to said input shaft for receiving torque from said input shaft and configured for supplying a fluid pressure to the transmission at a pre-determined pressure in response to torque transmitted through said input shaft.

10. A coupling system as set forth in claim 9 wherein said engine disconnect clutch includes a default position, wherein said default position is one of said engaged position of said engine disconnect clutch and said disengaged position of said engine disconnect clutch.

11. A coupling system as set forth in claim 10 wherein said engine disconnect clutch is in fluid communication with said transmission fluid pump and wherein said engine disconnect clutch is moveable out of said default position in response to a fluid pressure supplied by said transmission fluid pump.

12. A coupling system as set forth in claim 9 further comprising a one way clutch configured for interconnecting said input shaft and the engine and to permit torque transfer from the engine to the transmission and prevent torque transfer from said electric motor/generator to the engine.

13. A coupling system as set forth in claim 12 wherein said engine disconnect clutch and said one way clutch are arranged in parallel with each other.

14. A coupling system as set forth in claim 9 further including a torque limiting device configured for interconnecting said input shaft and the engine and to limit torque transfer between said input shaft and the engine to below a pre-determined level.

15. A transmission for a vehicle, the transmission comprising:
a housing including a bell portion and a gear portion;
a coupling system disposed within said bell portion of said housing and configured for coupling to an engine of the vehicle, said coupling system including:
an input shaft configured for receiving torque from the engine;
an engine disconnect clutch configured for selectively interconnecting said input shaft and the engine and moveable between an engaged position and a disengaged position, wherein said engaged position is configured for selectively connecting said input shaft with the engine to transmit torque between the engine and said input shaft and said disengaged position is configured for selectively disconnecting said input shaft from the engine to prevent transmission of torque between the engine and said input shaft;
an electric motor/generator coupled to said input shaft and configured for supplying a torque to said input shaft for transfer to at least one of the engine and the transmission and receiving a torque from said input shaft for generating electricity;
a fluid coupling configured for interconnecting said input shaft and the transmission to transmit torque from said input shaft to the transmission; and
a transmission fluid pump coupled to said input shaft and operable in response to torque from said input shaft to supply a fluid pressure to said engine disconnect clutch and the transmission at a pre-determined pressure;
wherein said engine disconnect clutch includes a default position being one of said engaged position of said engine disconnect clutch and said disengaged position of said engine disconnect clutch.

16. A transmission as set forth in claim 15 wherein said engine disconnect clutch is in fluid communication with said transmission fluid pump and wherein said engine disconnect clutch is moveable out of said default position in response to a fluid pressure supplied by said transmission fluid pump.

17. A transmission as set forth in claim 15 wherein said coupling system further includes a one way clutch configured for interconnecting said input shaft and the engine to permit torque transfer from the engine to the transmission and to prevent torque transfer from said electric motor to the engine.

18. A transmission as set forth in claim 17 wherein said engine disconnect clutch and said one way clutch are arranged in parallel with each other.

19. A transmission as set forth in claim 18 wherein said coupling system further includes a torque limiting device configured for interconnecting said input shaft and the engine to limit torque transfer between said input shaft and the engine to below a pre-determined level.
